(19) United States
(12) Patent Application Publication
(10) Pub. No.: US 2024/0097350 A1
(43) Pub. Date: Mar. 21, 2024

(54) WIRELESS COMMUNICATION THROUGH SHARED ANTENNA

(71) Applicant: Meta Platforms Technologies, LLC, Menlo Park, CA (US)

(72) Inventors: Qiuming Li, Palo Alto, CA (US); Abhishek Kumar Agrawal, Bellevue, WA (US); Xiangyu Kong, Shenzhen (CN)

(21) Appl. No.: 17/866,094

(22) Filed: Jul. 15, 2022

(51) Int. Cl. H01Q 21/28; H04B 1/00

(52) U.S. Cl. CPC H01Q 21/28; H04B 1/001

(57) ABSTRACT

Disclosed herein are related to systems and methods for wireless communication. In one aspect, a system includes a first wireless interface configured to communicate at a first frequency band and a second frequency band. In one aspect, the system includes a second wireless interface configured to communicate at a third frequency band and a fourth frequency band. In one aspect, the system includes a switch configured to select either communication at the second frequency band or the third frequency band. In one aspect, the system includes a multi-band filter configured to couple i) the first wireless interface, ii) the second wireless interface, and iii) the switch, to a single antenna.

### FIELD OF DISCLOSURE

The present disclosure is generally related to wireless communication, including but not limited to communication through different frequency bands via a shared antenna.

### BACKGROUND

Wireless devices may communicate with each other through a wireless medium (e.g., air). Each wireless device may include a transmitter to transmit a wireless signal, and a receiver to receive a wireless signal. A transmitter of a first wireless device may upconvert data for transmission at a baseband frequency to a radio frequency (RF) to generate a wireless signal, and transmit the wireless signal. A receiver of a second wireless device may receive the wireless signal at the RF, and downconvert the wireless signal to the baseband frequency to extract or obtain the data.

### SUMMARY

Various embodiments disclosed herein are related to a system for wireless communication. In some embodiments, the system includes a first wireless interface configured to communicate at a first frequency band and a second frequency band. In some embodiments, the system includes a second wireless interface configured to communicate at a third frequency band and a fourth frequency band. In some embodiments, the system includes a switch configured to select either communication at the second frequency band or the third frequency band. In some embodiments, the system includes a multi-band filter configured to couple i) the first wireless interface, ii) the second wireless interface, and iii) the switch, to a single antenna.

In some embodiments, each of the first frequency band, the second frequency band, the third frequency band and the fourth frequency band are different. In some embodiments, the second frequency band is higher than the first frequency band. In some embodiments, the third frequency band is higher than the second frequency band. In some embodiments, the fourth frequency band is higher than the third frequency band. In some embodiments, the first frequency band is between 2.3 GHz and 2.5 GHz, and the second frequency band is between 5.1 GHz and 7.125 GHz. In some embodiments, the third frequency band is between 6.2 GHz and 6.8 GHz, and the fourth frequency band is between 7.7 GHz and 8.3 GHz. In some embodiments, the first wireless interface is a wireless local area network (WLAN) transceiver, and the second wireless interface is an ultra-wide band (UWB) transceiver.

In some embodiments, the single antenna may communicate a first signal at the first frequency band, a second signal at the second frequency band, a third signal at the third frequency band, and a fourth signal at the fourth frequency band. In some embodiments, the multi-band filter includes a first filter to suppress or reject a first out-of-band signal of the first signal. In some embodiments, the multi-band filter includes a second filter to suppress or reject a second out-of-band signal of a combination of the second signal and the third signal. In some embodiments, the multi-band filter includes a third filter to suppress or reject a third out-of-band signal of the fourth signal.

In some embodiments, the first wireless interface includes a first port to communicate a first signal at the first frequency band, and a second port to communicate a second signal at the second frequency band. In some embodiments, the second wireless interface includes a third port to communicate a third signal at the third frequency band, and a fourth port to communicate a fourth signal at the fourth frequency band.

In some embodiments, the switch includes i) a first switch port coupled to the second port of the first wireless interface, ii) a second switch port coupled to the third port of the second wireless interface, and iii) a third switch port coupled to the multi-band filter. The switch may be configured to selectively couple the first switch port or the second switch port to the third switch port. In some embodiments, the multi-band filter includes i) a first multi-band filter port coupled to the first port of the first wireless interface, ii) a second multi-band filter port coupled to the third switch port of the switch, and iii) a third multi-band filter port coupled to the fourth port of the second wireless interface.

In some embodiments, the system includes a first filter coupled between the first multi-band filter port of the multi-band filter and the first port of the first wireless interface. In some embodiments, the system includes a second filter coupled between the first switch port of the switch and the second port of the first wireless interface. In some embodiments, the system includes a third filter coupled between the second switch port of the switch and the third port of the second wireless interface. In some embodiments, the system includes a fourth filter coupled between the third multi-band filter port of the multi-band filter and the fourth port of the second wireless interface.

In some embodiments, the first wireless interface is configured to communicate the first signal at the first frequency band, while the second wireless interface is configured to communicate the fourth signal at the fourth frequency band. In some embodiments, the first wireless interface is configured to communicate the second signal at the second frequency band through the switch, while the second wireless interface is configured to transmit or receive the fourth signal at the fourth frequency band, in response to the switch selecting the second signal. In some embodiments, the first wireless interface is configured to communicate the first signal at the first frequency band, while the second wireless interface is configured to transmit or receive the third signal at the third frequency band through the switch, in response to the switch selecting the third signal. In some embodiments, the second wireless interface is configured to communicate the fourth signal at the fourth frequency band, while the first wireless interface is configured to communicate the first signal at the first frequency band and the second signal at the second frequency band, in response to the switch selecting the second signal.

In some embodiments, the first wireless interface includes a first port to communicate a first signal at the first frequency band, and a second port to communicate a second signal at the second frequency band. In some embodiments, the second wireless interface includes a third port to transmit a third signal at the third frequency band or a fourth signal at the fourth frequency band, and a fourth port to receive a fifth signal at the third frequency band or a sixth signal at the fourth frequency band. In some embodiments, the system includes a mode switch to selectively couple the third port of the second wireless interface or the fourth port of the second wireless interface to the switch or the multi-band filter, according to a communication mode of the second wireless interface.

In some embodiments, the switch includes i) a first switch port coupled to the second port of the first wireless interface, ii) a second switch port, and iii) a third switch port coupled to the multi-band filter. In some embodiments, the switch is configured to selectively couple the first switch port or the second switch port to the third switch port. In some embodiments, the mode switch includes i) a fourth switch port coupled to the third port of the second wireless interface, ii) a fifth switch port coupled to the fourth port of the second wireless interface, iii) a sixth switch port coupled to the second switch port of the switch, and iv) a seventh switch port coupled to the multi-band filter. In some embodiments, the mode switch is configured to selectively couple i) the fourth switch port to the sixth switch port or the seventh switch port or ii) the fifth switch port to the sixth switch port or the seventh switch port, according to the communication mode of the second wireless interface.

In some embodiments, the multi-band filter includes i) a first multi-band filter port coupled to the first port of the first wireless interface, ii) a second multi-band filter port coupled to the third switch port of the switch, and iii) a third multi-band filter port coupled to the fourth port of the second wireless interface. In some embodiments, the system includes a first filter coupled between the first multi-band filter port of the multi-band filter and the first port of the first wireless interface. In some embodiments, the system includes a second filter coupled between the first switch port of the switch and the second port of the first wireless interface. In some embodiments, the system includes a third filter coupled between the second switch port of the switch and the sixth switch port of the mode switch. In some embodiments, the system includes a fourth filter coupled between the third multi-band filter port of the multi-band filter and the seventh switch port of the mode switch.

Various embodiments disclosed herein are related to a method of simultaneous communication at two or more of a first frequency band, a second frequency band, a third frequency band, and a fourth frequency band. In some embodiments, the method includes selecting, by a switch from the second frequency band and the third frequency band, the second frequency band for communication during a first time period. In some embodiments, the method includes communicating, by a first wireless interface, a first data at the second frequency band via a single antenna during the first time period. In some embodiments, the method includes communicating, by a second wireless interface, a second data at the fourth frequency band via the single antenna during the first time period. In some embodiments, the method includes selecting, by the switch from the second frequency band and the third frequency band, the third frequency band for communication during a second time period. In some embodiments, the method includes communicating, by the first wireless interface, a third data at the first frequency band via the single antenna during the second time period. In some embodiments, the method includes communicating, by the second wireless interface, a fourth data at the third frequency band or the fourth frequency band via the single antenna during the second time period.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a wireless device supporting communication at different frequency bands via a shared antenna, according to an example implementation of the present disclosure.

FIG. 3 is a diagram of a wireless device supporting communication at different frequency bands via a shared antenna, according to an example implementation of the present disclosure.

FIG. 4 is a flowchart showing a process of communicating through different frequency bands via a shared antenna, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems and methods for supporting wireless communication at different frequency bands and/or wireless communication conforming to different communication protocols. In one aspect, a system includes a first wireless interface configured to communicate at a first frequency band (e.g., WLAN or Wi-Fi 2.4 GHz band or Bluetooth band) and a second frequency band (e.g., WLAN or Wi-Fi 5 GHz and/or 6 GHz). In one aspect, the system includes a second wireless interface configured to communicate at a third frequency band (e.g., UWB channel 5 band) and a fourth frequency band (e.g., UWB channel 9 band). In one aspect, the system includes a switch configured to select communication at the second frequency band or the third frequency band. In one aspect, the system includes a multi-band filter (or a triplexer) configured to couple i) the first wireless interface, ii) the second wireless interface, and iii) the switch to the multi-band filter.

In one aspect, the second frequency band may be higher than the first frequency band, and the third frequency band may be higher than the second frequency band. In addition, the fourth frequency band may be higher than the third frequency band. For example, the first frequency band may be a 2.4 G channel (e.g., between 2.3 GHz and 2.5 GHz) of WLAN (e.g., Wi-Fi) communication or Bluetooth communication. For example, the second frequency band may be a 5 G channel (e.g., between 5.1 GHz and 5.9 GHz) and/or 6 G channel (e.g., between 5.925 GHz and 7.125 GHz) of WLAN (e.g., Wi-Fi) communication. For example, the third frequency band may be a channel 5 (e.g., between 6.2 GHz and 6.8 GHz) of ultra-wide band (UWB) communication. For example, the fourth frequency band may be a channel 9 (e.g., between 7.7 GHz and 8.3 GHz) of UWB communication.

Advantageously, the first wireless interface and the second wireless interface can simultaneously communicate at different frequency bands and/or with different wireless communication protocols via the shared antenna. For example, the first wireless interface can communicate at the first frequency band (e.g., 2.4 G channel of WLAN (e.g., Wi-Fi) or Bluetooth), while the second wireless interface can communicate at the third frequency band (e.g., channel 5 of UWB), at the fourth frequency band (e.g., channel 9 of UWB), or a combination of them. For example, the first wireless interface can communicate at the second frequency band (e.g., 5 G channel and/or 6 G channel of WLAN (e.g., Wi-Fi)), at the first frequency band (e.g., 2.4 G channel of WLAN (e.g., Wi-Fi) or Bluetooth), or a combination of them, while the second wireless interface can communicate at the fourth frequency band (e.g., channel 9 of UWB). By employing the first wireless interface, the second wireless interface, the switch, and the triplexer as disclosed herein, communication at different frequency bands and/or communication conforming to different wireless communication protocols can be simultaneously performed via the shared antenna.

Advantageously, the system can be implemented in a device having a small form factor. In one aspect, an antenna can occupy a large area compared to other components, such as wireless interfaces (or transceivers), filters, etc. By implementing a system that can support communication at various frequency bands and/or with communication protocols via a shared antenna, rather than via multiple antennas, the system can be implemented in a small form factor or in a small area, for example, for a wearable device (e.g., smart watch, smart phone, head wearable display, etc.).

Advantageously, the switch can select either the communication by the first wireless interface at the second frequency band (e.g., 5 G channel and/or 6 G channel of WLAN (e.g., Wi-Fi)) and communication by the second wireless interface at the third frequency band (e.g., channel 5 of UWB) to avoid interference. In one aspect, the separation between 5 G channel of WLAN (e.g., Wi-Fi) and channel 5 of UWB may not be large enough, such that filters may not sufficiently suppress or reject out-of-band signals for a signal at 5 G channel of WLAN (e.g., Wi-Fi) and/or out-of-band signals for a signal at the channel 5 of UWB. Moreover, 6 G channel of WLAN (e.g., Wi-Fi) and channel 5 of UWB may overlap with each other. Without sufficient suppression or rejection of out-of-band signals, simultaneous communication at the second frequency band (e.g., 5 G channel and/or 6 G channel of WLAN (e.g., Wi-Fi)) and the third frequency band (e.g., channel 5 of UWB) may interfere with each other. In one aspect, the switch can be implemented to ensure that communication by the first wireless interface at the second frequency band (e.g., 5 G channel and/or 6 G channel of WLAN (e.g., Wi-Fi)) and communication by the second wireless interface at the third frequency band (e.g., channel 5 of UWB) may not be performed concurrently, so as to avoid interference.

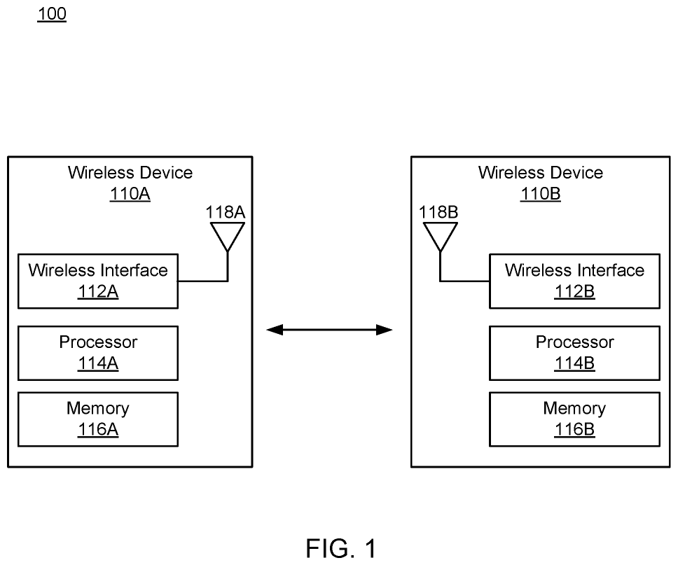

FIG. 1 is a diagram of an example wireless communication system 100, according to an example implementation of the present disclosure. In some embodiments, the wireless communication system 100 includes wireless devices 110A, 110B. Each of the wireless devices 110A, 110B may be any device that can communicate through a wireless link. Each of the wireless devices 110A, 110B may be an access point, base station, router, smart phone, laptop, tablet PC, etc. The wireless link may be a cellular communication link (e.g., 3G, 4G, 5G), Wi-Fi communication link, Bluetooth communication link, 60 GHz communication link, UWB link, or any communication link. In some embodiments, the wireless communication system 100 includes more wireless devices than shown in FIG. 1.

In some embodiments, the wireless device 110A includes a wireless interface 112A, a processor 114A, a memory device 116A, and one or more antennas 118A. Similarly, the wireless device 110B includes a wireless interface 112B, a processor 114B, a memory device 116B, and one or more antennas 118B. These components may be embodied as hardware, software, firmware, or a combination thereof. In some embodiments, the wireless devices 110A, 110B include more, fewer, or different components than shown in FIG. 1. For example, the wireless devices 110A, 110B may each include an electronic display and/or an input device. For example, the wireless devices 110A, 110B may each include one or more additional antennas 118 than shown in FIG. 1.

The antenna 118 may be a component that receives a radio frequency (RF) signal and/or transmits a RF signal through a wireless medium (e.g., air). The RF signal may be at a frequency between 200 MHz to 100 GHz. The RF signal may have packets, symbols, or frames corresponding to data for communication. The antenna 118 may be a dipole antenna, a patch antenna, a ring antenna, or any suitable antenna for wireless communication. In one aspect, an antenna 118 is utilized for both transmitting a RF signal and receiving a RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through one or more antennas 118. In one configuration, the wireless interface 112 is coupled to one or more antennas 118. In one aspect, the wireless interface 112 may receive the RF signal at the RF received through an antenna 118, and downconvert the RF signal to a baseband frequency (e.g., 0˜1 GHz). The wireless interface 112 may provide the downconverted signal to the processor 114. In one aspect, the wireless interface 112 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as field programmable gate array (FPGA), application specific integrated circuit (ASIC), a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data, and present an audio indicated by the audio data and/or an image indicated by the image data to a user of the wireless device 110. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission.

The memory device 116 is a component that stores data. The memory device 116 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 116 may be embodied as a non-transitory computer readable medium storing instructions executable by the processor 114 to perform various functions of the wireless device 110 disclosed herein. In some embodiments, the memory device 116 and the processor 114 are integrated as a single component.

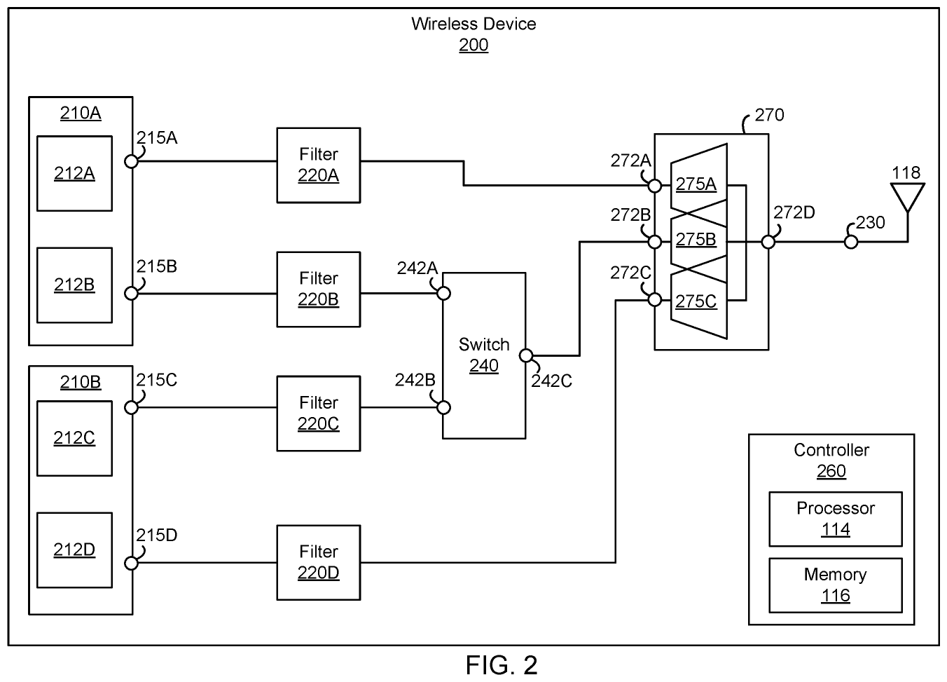

FIG. 2 is a diagram of a wireless device 200 supporting communication at different frequency bands via a shared antenna, according to an example implementation of the present disclosure. The wireless device 200 can be the wireless device 110A or the wireless device 110B. In some embodiments, the wireless device 200 can be or implemented as part of a wearable device (e.g., smart watch, smart phone, head wearable display, etc.). In some embodiments, the wireless device 200 includes an antenna 118, wireless interfaces 210A, 210B, filters 220A . . . 220D, a switch 240, a multi-band filter 270, and a controller 260. These components may operate together to receive or transmit RF signals at a RF. In one configuration, the wireless transceiver 210A includes a first port 215A and a second port 215B that can be connected to the antenna 118 through various components of the wireless device 200. Similarly, the wireless transceiver 210B includes a third port 215C and a fourth port 215D that can be connected to the antenna 118 through various components of the wireless device 220. Hence, the wireless transceivers 210A, 210B can communicate via the shared antenna 118. In some embodiments, the wireless device 200 includes more, fewer, or different components than shown in FIG. 2. In one example, the antenna 118 can be detachable from the wireless device 200.

In some embodiments, the antenna 200 may be a hardware component that transmits or receives a RF signal through a wireless medium (e.g., air space). The RF signal may have packets, symbols, or frames corresponding to data for communication. The antenna 118 may be/include a dipole antenna, a patch antenna, a ring antenna, a slot antenna, or any suitable antenna for wireless communication. In one aspect, the antenna 200 is designed or tuned to transmit or receive a RF signal for a wide frequency range, for example, between 2 GHz to 10 GHz. Hence, a single antenna can be utilized to support communication for a wide frequency range, and/or or communication conforming to various wireless communication protocols (e.g., WLAN (e.g., Wi-Fi), Bluetooth, UWB, etc.). In some embodiments, the antenna 200 can be coupled to an antenna port 230. The antenna port 230 may be a conductive component, to which the antenna 118 can be physically connected. For example, the antenna 118 includes a connector that can be clipped to or screwed to the antenna port 230. In some embodiments, the connector of the antenna 118 is detachable from the antenna port 230 to allow replacement of the antenna 118. In some embodiments, the antenna port 230 can be embodied as a switch connector. If there is no test cable plugged in, the switch connector can be a passthrough electrically connecting the antenna 118 to the multi-band filter 270. If there is a test cable plugged in to the switch connector, the switch connector can electrically connect the test cable to the multi-band filter 270 and electrically disconnect the antenna 118 from the multi-band filter 270.

In some embodiments, the multi-band filter 270 is a hardware component that can suppress or reject out-of-band signals (e.g., according to a plurality of defined pass-bands) for various in-band signals. The multi-band filter 270 may be embodied as a triplexer. In one configuration, the multi-band filter 270 includes i) a first multi-band filter port 272A coupled to the first port 215A of the wireless interface 210A, ii) a second multi-band filter port 272B coupled to the switch 240, iii) a third multi-band filter port 272C coupled to the fourth port 215D of the wireless interface 210B, and/or iv) a fourth multi-band filter port 272D coupled to the antenna port 230. In some embodiments, the antenna port 230 and the fourth multi-band filter port 272D can be implemented as a single port. In one aspect, the multi-band filter 270 includes three filters 275A, 275B, 275C. In some embodiments, the filter 275A can be a low pass filter or a band pass filter. In some embodiments, the filter 275B can be a band pass filter. In some embodiments, the filter 275C can be a high pass filter or a band pass filter. The filter 275A can be coupled between the first multi-band filter port 272A and the fourth multi-band filter port 272D. The filter 275B can be coupled between the second multi-band filter port 272B and the fourth multi-band filter port 272D. The filter 275C can be coupled between the third multi-band filter port 272C and the fourth multi-band filter port 272D. Each filter 275 can reject or suppress an out-of-band signal for a corresponding in-band signal. For example, the filter 275A can reject or suppress out-of-band signals for an in-band signal at a frequency range between 2.3 GHz and 2.5 GHz. For example, the filter 275B can reject or suppress out-of-band signals for an in-band signal at a frequency range between 5.1 GHz and 7.125 GHz. For example, the filter 275C can reject or suppress out-of-band signals for an in-band signal at a frequency range between 7.7 GHz and 8.3 GHz. In this configuration, a RF signal at different frequency bands from the antenna 118 can be filtered by the filters 275A, 275B, 275C, and different filtered signals can be provided at respective multi-band filter ports 272A, 272B, 272C. In addition, different RF signals at different frequency bands from the wireless interfaces 210A, 210B can be combined (or allowed to pass and/or merged onto a transmission path) by the multi-band filter 270, and the combined RF signal can be transmitted via the antenna 118.

In some embodiments, the switch 240 is a hardware component that can selectively couple the wireless interface 210A or the wireless interface 210B to the multi-band filter 270, according to a control signal or a command from the controller 260. The switch 240 can be embodied as a RF switch with a low parasitic resistance and low parasitic capacitance to provide sufficient isolation between the ports 242A, 242B. In one configuration, the switch 240 includes a first switch port 242A coupled to the second port 215B of the wireless interface 210A, a second switch port 242B coupled to the third port 215C of the wireless interface 210B, and a third switch port 242C coupled to the second multi-band filter port 272B of the multi-band filter 270. In this configuration, the switch 240 can electrically couple the first switch port 242A or the second switch port 242B to the third switch port 242C, according to the control signal or the command. Hence, the second port 215B of the wireless interface 210A or the third port 215C of the wireless interface 210B can be selectively coupled to the second multi-band filter port 272B of the multi-band filter 270 through the switch 240.

In some embodiments, the filter 220A is a hardware component that can reject or suppress an out-of-band signal for an in-band signal. The filter 220A can be implemented as a band pass filter. In one configuration, the filter 220A can be coupled between the first port 215A of the wireless interface 210A and the first multi-band filter port 272A of the multi-band filter 270. In this configuration, the filter 220A can provide additional filtering for the filter 275A to reject or suppress out-of-band signals for the in-band signal at a frequency range between 2.3 GHz and 2.5 GHz. In some embodiments, the filter 220A can be omitted, if the filter 275A can provide sufficient rejection.

In some embodiments, the filter 220B is a hardware component that can reject or suppress an out-of-band signal for an in-band signal. The filter 220B can be implemented as a band pass filter. In one configuration, the filter 220B can be coupled between the second port 215B of the wireless interface 210A and the first switch port 242A of the switch 240. In this configuration, the filter 220B can provide additional filtering for the filter 275B to reject or suppress out-of-band signals for the in-band signal at a frequency range between 5.1 GHz and 5.9 GHz or between 5.1 GHz and 7.125 GHz. In some embodiments, the filter 220B can be omitted, if the filter 275B can provide sufficient rejection.

In some embodiments, the filter 220C is a hardware component that can reject or suppress an out-of-band signal for an in-band signal. The filter 220C can be implemented as a band pass filter. In one configuration, the filter 220C can be coupled between the third port 215C of the wireless interface 210B and the second switch port 242B of the switch 240. In this configuration, the filter 220C can provide additional filtering for the filter 275B to reject or suppress out-of-band signals for the in-band signal at a frequency range between 6.2 GHz and 6.8 GHz. In some embodiments, the filter 220C can be omitted, if the filter 275B can provide sufficient rejection.

In some embodiments, the filter 220D is a hardware component that can filter an out-of-band signal for an in-band signal. The filter 220D can be implemented as a band pass filter. In one configuration, the filter 220D can be coupled between the fourth port 215D of the wireless interface 210B and the third multi-band filter port 272C of the multi-band filter 270. In this configuration, the filter 220D can provide additional filtering for the filter 275C to filter or suppress out-of-band signals for the in-band signal at a frequency range between 7.7 GHz and 8.3 GHz. In some embodiments, the filter 220D can be omitted, if the filter 275C can provide sufficient rejection.

In some embodiments, the wireless interface 210A is a hardware component that transmits or receives a RF signal. The wireless interface 112 may include a first transceiver 212A and a second transceiver 212B. The first transceiver 212A may be coupled to the first port 215A, and the second transceiver 212B may be coupled to the second port 215B.

In one aspect, the first transceiver 212A may be a transceiver for communication at a first frequency band (e.g., 2.3 GHz and 2.5 GHz) of a WLAN communication protocol (e.g., Wi-Fi) and/or a Bluetooth communication protocol. In one aspect, the first transceiver 212A may receive data at a baseband, for example, from the controller 260, and can generate a RF signal including or corresponding to the received data for the first port 215A. The RF signal for the first port 215A may be at a frequency band between 2.3 GHz and 2.5 GHz of the WLAN (e.g., Wi-Fi) or Bluetooth communication protocol. The first transceiver 212A may provide or output the RF signal through the first port 215A for transmission via the filter 220A, the multi-band filter 270, and the antenna 118. In addition, through the first port 215A, the first transceiver 212A may receive a RF signal at the frequency band between 2.3 GHz and 2.5 GHz of the WLAN (e.g., Wi-Fi) or Bluetooth communication protocol via the antenna 118, the multi-band filter 270, and the filter 220A. The first transceiver 212A may downconvert the received RF signal to obtain data contained in the received RF signal. The first transceiver 212A may provide the obtained data to the controller 260.

In one aspect, the second transceiver 212B may be a transceiver for communication at a second frequency band (e.g., 5.1 GHz and 5.9 GHz and/or 5.925 GHz and 7.125 GHz) of the WLAN (e.g., Wi-Fi) communication protocol. In one aspect, the second transceiver 212B may receive data at a baseband, for example, from the controller 260, and generate a RF signal including or corresponding to the received data for the second port 215B. The RF signal for the second port 215B may be at a frequency band between 5.1 GHz and 5.9 GHz and/or between 5.925 GHz and 7.125 GHz of the WLAN (e.g., Wi-Fi) communication protocol. The second transceiver 212B may provide or output the RF signal through the second port 215B for transmission via the filter 220B, the switch 240, the multi-band filter 270, and the antenna 118. In addition, through the second port 215B, the second transceiver 212B may receive a RF signal at the frequency band between 5.1 GHz and 5.9 GHz and/or between 5.925 GHz and 7.125 GHz of the WLAN (e.g., Wi-Fi) communication protocol via the antenna 118, the multi-band filter 270, the switch 240, and the filter 220B. The second transceiver 212B may downconvert the received RF signal to obtain data contained in the received RF signal. The second transceiver 212B may provide the obtained data to the controller 260.

In some embodiments, the wireless interface 210B is a hardware component that generates or receives a RF signal. The wireless interface 210B may include a third transceiver 212C and a fourth transceiver 212D. The third transceiver 212C may be coupled to the third port 215C, and the fourth transceiver 212D may be coupled to the fourth port 215D.

In one aspect, the third transceiver 212C may be a transceiver for communication at a third frequency band (e.g., 6.2 GHz and 6.8 GHz) of the channel 5 of UWB communication protocol. In one aspect, the third transceiver 212C may receive data at a baseband, for example, from the controller 260, and can generate a RF signal including or corresponding to the received data for the third port 215C. The RF signal for the third port 215C may be at a frequency band between 6.2 GHz and 6.8 GHz of the channel 5 of UWB communication protocol. The third transceiver 212C may provide or output the RF signal through the third port 215C for transmission via the filter 220C, the switch 240, the multi-band filter 270, and the antenna 118. In addition, through the third port 215C, the third transceiver 212C may receive a RF signal at the frequency band between 6.2 GHz and 6.8 GHz of the channel 5 of UWB communication protocol via the antenna 118, the multi-band filter 270, the switch 240, and the filter 220C. The third transceiver 212C may downconvert the received RF signal to obtain data contained in the received RF signal. The third transceiver 212C may provide the obtained data to the controller 260.

In one aspect, the fourth transceiver 212D may be a transceiver for communication at a fourth frequency band (e.g., 7.7 GHz and 8.3 GHz) of the channel 9 of UWB communication protocol. In one aspect, the fourth transceiver 212D may receive data at a baseband, for example, from the controller 260, and generate a RF signal including or corresponding to the received data for the fourth port 215D. The RF signal for the fourth port 215D may be at a frequency band between 7.7 GHz and 8.3 GHz of the channel 9 of UWB communication protocol. The fourth transceiver 212D may provide or output the RF signal through the fourth port 215D for transmission via the filter 220D, the multi-band filter 270, and the antenna 118. In addition, through the fourth port 215D, the fourth transceiver 212D may receive a RF signal at the frequency band between 7.7 GHz and 8.3 GHz of the channel 9 of UWB communication protocol via the antenna 118, the multi-band filter 270, and the filter 220D. The fourth transceiver 212D may downconvert the received RF signal to obtain data contained in the received RF signal. The fourth transceiver 212D may provide the obtained data to the controller 260.

In some embodiments, the controller 260 is a hardware component or a combination of a hardware component and a software component that controls operations of various components of the wireless device 200. In some embodiments, the controller 260 includes the processor 114 and the memory device 116. The processor 114 may execute one or more instructions stored by the memory device 116 or a non-transitory computer readable medium to perform various functions of the processor 114 or the wireless device 200 described herein. In one aspect, the processor 114 may generate and can provide content data at a baseband to wireless transceivers 210A, 210B for transmission. In one aspect, the processor 114 may receive content data at the baseband from the wireless transceivers 210A, 210B for reception.

In one aspect, the processor 114 or the controller 260 can configure the switch 240 according to a communication mode. An example of the communication mode includes a first communication mode to support i) TX or RX communication at a frequency band between 2.3 GHz and 2.5 GHz of the WLAN (e.g., Wi-Fi) or Bluetooth communication protocol, or ii) TX or RX communication at a frequency band (e.g., 7.7 GHz and 8.3 GHz) of the channel 9 of UWB communication protocol, or a combination of them, while supporting TX or RX communication at a frequency band between 5.1 GHz and 5.9 GHz and/or between 5.925 GHz and 7.125 GHz of the WLAN (e.g., Wi-Fi) communication protocol. An additional example of the communication mode includes a second communication mode to support i) TX or RX communication at the frequency band between 2.3 GHz and 2.5 GHz of the WLAN (e.g., Wi-Fi) or Bluetooth communication protocol, or ii) TX or RX communication at a frequency band (e.g., 7.7 GHz and 8.3 GHz) of the channel 9 of UWB communication protocol, or a combination of them, while supporting TX or RX communication at a frequency band (e.g., 6.2 GHz and 6.8 GHz) of the channel 5 of UWB communication protocol. An additional example of the communication mode includes a third communication mode to support TX or RX communication at the frequency band between 2.3 GHz and 2.5 GHz of the WLAN (e.g., Wi-Fi) or Bluetooth communication protocol, while supporting TX or RX communication at the frequency band between 5.1 GHz and 5.9 GHz and/or between 5.925 GHz and 7.125 GHz of the WLAN (e.g., Wi-Fi) communication protocol. An additional example of the communication mode includes a fourth communication mode to support TX or RX communication at the frequency band (e.g., 6.2 GHz and 6.8 GHz) of the channel 5 of UWB communication protocol, while supporting TX or RX communication at the frequency band (e.g., 7.7 GHz and 8.3 GHz) of the channel 9 of UWB communication protocol. In one aspect, the controller 260 can generate a control signal to configure/set/program the switch 240, according to the selected communication mode. The controller 260 can provide the control signal to the switch 240. In response to the control signal, the switch 240 may electrically couple the port 215B or the port 215C to the multi-band filter port 272B. Hence, a selected one of i) communication at a frequency band between 5.1 GHz and 5.9 GHz and/or between 5.925 GHz and 7.125 GHz of the WLAN (e.g., Wi-Fi) communication protocol or ii) communication at a frequency band (e.g., 6.2 GHz and 6.8 GHz) of the channel 5 of UWB communication protocol can be supported, while communication at other frequency bands can be supported.

Advantageously, the switch 240 can obviate interference of communication at the frequency band (e.g., 5 G channel and/or 6 G channel of WLAN (e.g., Wi-Fi)) and communication at the frequency band (e.g., channel 5 of UWB). In one aspect, the separation between 5 G channel of WLAN (e.g., Wi-Fi) and channel 5 of UWB may not be large enough, such that the filter 220B may not sufficiently suppress or reject an out-of-band signal for a signal at the second frequency band, and the filter 220C may not sufficiently suppress or reject an out-of-band signal for a signal at the third frequency band. Moreover, 6 G channel of WLAN (e.g., Wi-Fi) may overlap with channel 5 of UWB. Without sufficient suppression or rejection of out-of-band signals, simultaneous communication at the second frequency band (e.g., 5 G channel and/or 6 G channel of WLAN (e.g., Wi-Fi)) and the third frequency band (e.g., channel 5 of UWB) may interfere with each other. In one aspect, the switch 240 can be implemented to ensure that communication by the wireless interface 210A at the second frequency band (e.g., 5 G channel and/or 6 G channel of WLAN (e.g., Wi-Fi)) and communication by the wireless interface 210B at the third frequency band (e.g., channel 5 of UWB) may not be performed concurrently to avoid interference.

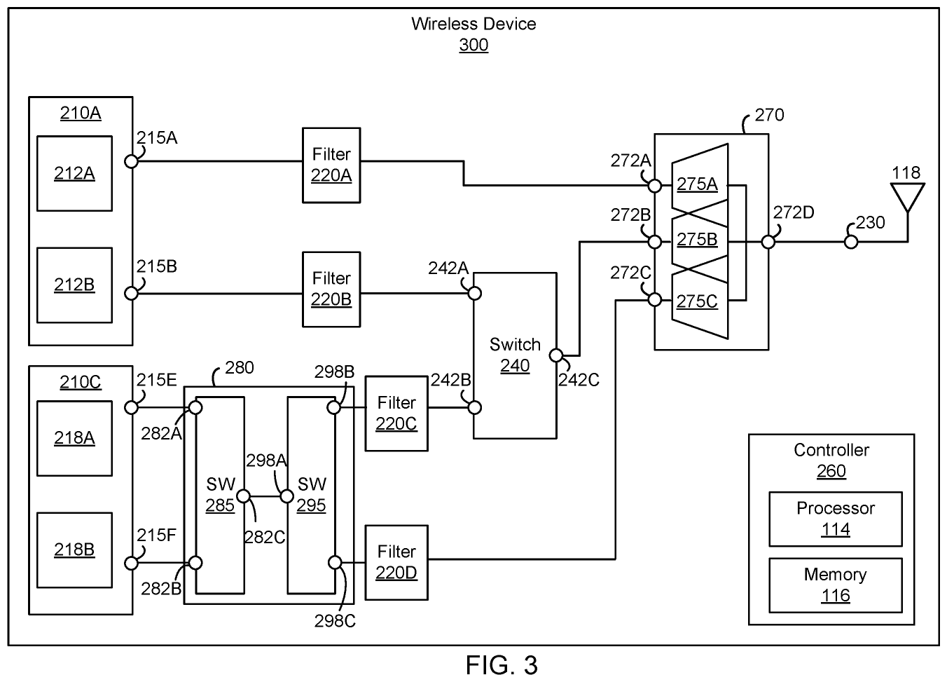

FIG. 3 is a diagram of a wireless device 300 supporting communication at different frequency bands via a shared antenna, according to an example implementation of the present disclosure. In some embodiments, the wireless device 300 can be the wireless device 110A or the wireless device 110B. In some embodiments, the wireless device 300 can be or implemented as part of a wearable device (e.g., smart watch, smart phone, head wearable display, etc.). In one aspect, the wireless device 300 is similar to the wireless device 200, except the wireless device 300 includes a wireless interface 210C instead of the wireless interface 210B and includes a mode switch 280 between the wireless interface 210C and the filters 220C, 220D. Thus, detailed description of duplicated portion thereof is omitted herein for the sake of brevity.

In some embodiments, the mode switch 280 is a component that can selectively couple the wireless transceiver 210C to the switch 240 or the multi-band filter 270. In some embodiments, the mode switch 280C includes switches 285, 295. In one configuration, the switch 285 includes a switch port 282A coupled to a port 215E of the wireless transceiver 210C, a switch port 282B coupled to a port 215F of the wireless transceiver 210C, and a switch port 282C. In one configuration, the switch 295 includes a switch port 298A coupled to the switch port 282C, a switch port 298B coupled to the second switch port 242B of the switch 240, and a switch port 298C coupled to a multi-band filter port 272C of the multi-band filter 270. In this configuration, the mode switch 280 may receive a control signal from the controller 260, and can configure the switches 285, 295, according to the control signal. The control signal may indicate or correspond to a communication mode (e.g., receive a signal at channel 5 of UWB, transmit a signal at channel 5 of UWB, receive a signal at channel 9 of UWB, transmit a signal at channel 9 of UWB, etc.). For example, the mode switch 280 may electrically couple i) the switch port 282A to the switch port 298B or the switch port 298C, or ii) the switch port 282B to the switch port 298B or the switch port 298C, according to the control signal.

In some embodiments, the wireless interface 210D is a hardware component that generates or receives a RF signal. The wireless interface 210D may include a dual band transmitter 218A (or a wide band transmitter 218A) and a dual band receiver 218B (or a wide band receiver 218B). The dual band transmitter 218A may be coupled to the port 215E, and the dual band receiver 218B may be coupled to the port 215F.

In one aspect, the dual band transmitter 218A may be a transmitter for communication at a third frequency band (e.g., 6.2 GHz and 6.8 GHz) of the channel 5 of UWB communication protocol and a fourth frequency band (e.g., 7.7 GHz and 8.3 GHz) of the channel 9 of UWB communication protocol. In one aspect, the dual band transmitter 218A may receive data at a baseband, for example, from the controller 260, and can generate a RF signal including or corresponding to the received data. The RF signal may be at a frequency band between 6.2 GHz and 6.8 GHz of the channel 5 of UWB communication protocol, or at a frequency band between 7.7 GHz and 8.3 GHz of the channel 9 of UWB communication protocol. The dual band transmitter 218A may provide or output the RF signal at the third frequency band (e.g., 6.2 GHz and 6.8 GHz) of the channel 5 of UWB communication protocol through the port 215E for transmission via the mode switch 280, the filter 220C, the switch 240, the multi-band filter 270, and the antenna 118. Additionally or alternatively, the dual band transmitter 218A may provide or output the RF signal at the fourth frequency band (e.g., 7.7 GHz and 8.3 GHz) of the channel 9 of UWB communication protocol through the port 215E for transmission via the mode switch 280, the filter 220C, the switch 240, the multi-band filter 270, and the antenna 118.

In one aspect, the dual band receiver 218B may be a receiver for communication at a third frequency band (e.g., 6.2 GHz and 6.8 GHz) of the channel 5 of UWB communication protocol and a fourth frequency band (e.g., 7.7 GHz and 8.3 GHz) of the channel 9 of UWB communication protocol. In one aspect, the dual band receiver 218B may receive a RF signal through the port 215F. The dual band receiver 218B may receive the RF signal at the third frequency band (e.g., 6.2 GHz and 6.8 GHz) of the channel 5 of UWB communication protocol through the port 215F for reception via the antenna 118, the multi-band filter 270, the switch 240, the filter 220C, and the mode switch 280. Additionally or alternatively, the dual band receiver 218B may receive the RF signal at the fourth frequency band (e.g., 7.7 GHz and 9.8 GHz) of the channel 9 of UWB communication protocol through the port 215F for reception via the antenna 118, the multi-band filter 270, the filter 220D, and the mode switch 280. The dual band receiver 218B may downconvert the received RF signal to obtain data contained in the received RF signal. The received RF signal may be at the third frequency band (e.g., 6.2 GHz and 6.8 GHz) of the channel 5 of UWB communication protocol and a fourth frequency band (e.g., 7.7 GHz and 8.3 GHz) of the channel 9 of UWB communication protocol. The dual band receiver 218B may provide the obtained data to the controller 260.

In one aspect, the processor 114 or the controller 260 can configure the mode switch 280 according to a communication mode. In one aspect, the controller 260 can generate a control signal to configure the switches 285, 295, according to the selected communication mode. The controller 260 can provide the control signal to the mode switch 280. In response to the control signal, the mode switch 280 may electrically couple i) the port 215E or ii) the port 215F, to i) the switch port 242B or ii) the multi-band filter port 272C. For example, to transmit a RF signal at the third frequency band (e.g., 6.2 GHz and 6.8 GHz) of the channel 5 of UWB communication protocol, the mode switch 280 may electrically couple the port 215E of the dual band transmitter 218A to the switch port 242B. For example, to transmit a RF signal at the fourth frequency band (e.g., 7.7 GHz and 8.3 GHz) of the channel 9 of UWB communication protocol, the mode switch 280 may electrically couple the port 215E of the dual band transmitter 218A to the multi-band filter port 272C. For example, to receive a RF signal at the third frequency band (e.g., 6.2 GHz and 6.8 GHz) of the channel 5 of UWB communication protocol, the mode switch 280 may electrically couple the port 215F of the dual band receiver 218B to the switch port 242B. For example, to receive a RF signal at the fourth frequency band (e.g., 7.7 GHz and 8.3 GHz) of the channel 9 of UWB communication protocol, the mode switch 280 may electrically couple the port 215F of the dual band receiver 218B to the multi-band filter port 272C. Hence, the wireless transceiver 210C and the mode switch 280 may be configured to operate in a similar manner as the wireless transceiver 210B of FIG. 2.

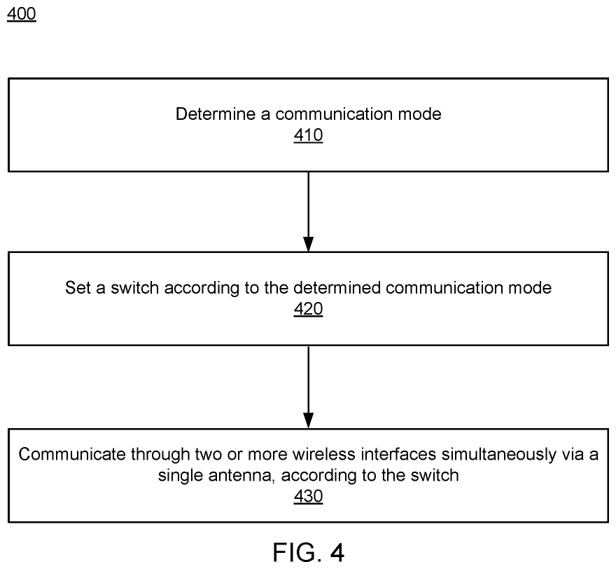

FIG. 4 is a flowchart showing a process 400 of communicating through different frequency bands via a shared antenna, according to an example implementation of the present disclosure. In some embodiments, the process 400 is performed by the wireless device 110, the wireless device 200, or the wireless device 300. In some embodiments, the process 400 is performed by other entities. In some embodiments, the process 400 includes more, fewer, or different steps than shown in FIG. 4.

In one approach, the wireless device determines 410 a communication mode to support simultaneous communication at different frequency bands and/or with different communication protocols. An example of the communication mode includes a first communication mode to support i) TX or RX communication at a frequency band between 2.3 GHz and 2.5 GHz of the WLAN (e.g., Wi-Fi) or Bluetooth communication protocol, or ii) TX or RX communication at a frequency band (e.g., 7.7 GHz and 8.3 GHz) of the channel 9 of UWB communication protocol, or a combination of them, while supporting TX or RX communication at a frequency band between 5.1 GHz and 5.9 GHz and/or between 5.925 GHz and 7.125 GHz of the WLAN (e.g., Wi-Fi) communication protocol. An additional example of the communication mode includes a second communication mode to support i) TX or RX communication at the frequency band between 2.3 GHz and 2.5 GHz of the WLAN (e.g., Wi-Fi) or Bluetooth communication protocol, or ii) TX or RX communication at a frequency band (e.g., 7.7 GHz and 8.3 GHz) of the channel 9 of UWB communication protocol, or a combination of them, while supporting TX or RX communication at a frequency band (e.g., 6.2 GHz and 6.8 GHz) of the channel 5 of UWB communication protocol. An additional example of the communication mode includes a third communication mode to support TX or RX communication at the frequency band between 2.3 GHz and 2.5 GHz of the WLAN (e.g., Wi-Fi) or Bluetooth communication protocol, while supporting TX or RX communication at the frequency band between 5.1 GHz and 5.9 GHz and/or between 5.925 GHz and 7.125 GHz of the WLAN (e.g., Wi-Fi) communication protocol. An additional example of the communication mode includes a fourth communication mode to support TX or RX communication at the frequency band (e.g., 6.2 GHz and 6.8 GHz) of the channel 5 of UWB communication protocol, while supporting TX or RX communication at the frequency band (e.g., 7.7 GHz and 8.3 GHz) of the channel 9 of UWB communication protocol.

In one approach, the wireless device sets 420 a switch 240 according to the determined communication mode. The wireless device may generate a control signal corresponding to the selected configuration mode (e.g., communication at a frequency band between 5.1 GHz and 5.9 GHz and/or between 5.925 GHz and 7.125 GHz of the WLAN (e.g., Wi-Fi) communication protocol or communication at a frequency band (e.g., 6.2 GHz and 6.8 GHz) of the channel 5 of UWB communication protocol). The wireless device may apply the control signal to the switch 240, such that the switch 240 may electrically couple the wireless transceiver 210A or the wireless transceiver 220B (or the wireless transceiver 220C) to the multi-band filter 270, according to the control signal.

In one approach, the wireless device communicates 430 through two or more wireless interfaces 210A, 210B (or 210C) simultaneously via the single antenna 118, according to the switch 240. For example, when the switch 240 electrically couples the wireless transceiver 210A to the multi-band filter 270, the wireless transceiver 210A may communicate at a frequency band between 2.3 GHz and 2.5 GHz of the WLAN (e.g., Wi-Fi) or Bluetooth communication protocol, or ii) the wireless transceiver 210B may communicate at a frequency band (e.g., 7.7 GHz and 8.3 GHz) of the channel 9 of UWB communication protocol, or a combination of them, while the wireless transceiver 210A communicates at a frequency band between 5.1 GHz and 5.9 GHz and/or between 5.925 GHz and 7.125 GHz of the WLAN (e.g., Wi-Fi) communication protocol. For example, when the switch 240 electrically couples the wireless transceiver 210B to the multi-band filter 270, the wireless transceiver 210A may communicate at a frequency band between 2.3 GHz and 2.5 GHz of the WLAN (e.g., Wi-Fi) or Bluetooth communication protocol, or ii) the wireless transceiver 210B may communicate at a frequency band (e.g., 7.7 GHz and 8.3 GHz) of the channel 9 of UWB communication protocol, or a combination of them, while the wireless transceiver 210B communicates at a frequency band between 6.2 GHz and 6.8 GHz of the channel 5 of UWB communication protocol).

Advantageously, the wireless device can be implemented in a small form factor. In one aspect, an antenna can occupy a large area compared to other components, such as wireless interfaces (or transceivers), filters, etc. By implementing the wireless device that can support communication at various frequency bands and/or with communication protocols via a shared antenna, rather than via multiple antennas, the wireless device can be implemented in a small form factor or in a small area, for example, for a wearable device (e.g., smart watch, smart phone, head wearable display, etc.).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system comprising:
a first wireless interface configured to communicate at a first frequency band and a second frequency band;
a second wireless interface configured to communicate at a third frequency band and a fourth frequency band;
a switch configured to select communication at the second frequency band or the third frequency band; and
a multi-band filter configured to couple i) the first wireless interface, ii) the second wireless interface, and iii) the switch, to a single antenna.

2. The system of claim 1, wherein each of the first frequency band, the second frequency band, the third frequency band and the fourth frequency band are different.

3. The system of claim 1, wherein the first frequency band is between 2.3 GHz and 2.5 GHz, and the second frequency band is between 5.1 GHz and 7.125 GHz.

4. The system of claim 3, wherein the third frequency band is between 6.2 GHz and 6.8 GHz, and the fourth frequency band is between 7.7 GHz and 8.3 GHz.

5. The system of claim 1, wherein the first wireless interface is a wireless local area network (WLAN) transceiver, and the second wireless interface is an ultra wide band (UWB) transceiver.

6. The system of claim 1, further comprising:
the single antenna to communicate a first signal at the first frequency band, a second signal at the second frequency band, a third signal at the third frequency band, and a fourth signal at the fourth frequency band.

7. The system of claim 6, wherein the multi-band filter includes:
a first filter to suppress or reject a first out-of-band signal of the first signal,
a second filter to suppress or reject a second out-of-band signal of a combination of the second signal and the third signal, and
a third filter to suppress or reject a third out-of-band signal of the fourth signal.

8. The system of claim 1,
wherein the first wireless interface includes:
a first port to communicate a first signal at the first frequency band, and
a second port to communicate a second signal at the second frequency band, and
wherein the second wireless interface includes:
a third port to communicate a third signal at the third frequency band, and
a fourth port to communicate a fourth signal at the fourth frequency band.

9. The system of claim 8, wherein the switch includes:
a first switch port coupled to the second port of the first wireless interface,
a second switch port coupled to the third port of the second wireless interface, and
a third switch port coupled to the multi-band filter, wherein the switch is configured to selectively couple the first switch port or the second switch port to the third switch port.

10. The system of claim 9, wherein the multi-band filter includes:
a first multi-band filter port coupled to the first port of the first wireless interface,
a second multi-band filter port coupled to the third switch port of the switch, and
a third multi-band filter port coupled to the fourth port of the second wireless interface.

11. The system of claim 10, further comprising:
a first filter coupled between the first multi-band filter port of the multi-band filter and the first port of the first wireless interface;
a second filter coupled between the first switch port of the switch and the second port of the first wireless interface;
a third filter coupled between the second switch port of the switch and the third port of the second wireless interface; and
a fourth filter coupled between the third multi-band filter port of the multi-band filter and the fourth port of the second wireless interface.

12. The system of claim 8, wherein the first wireless interface is configured to communicate the first signal at the first frequency band, while the second wireless interface is configured to communicate the fourth signal at the fourth frequency band.

13. The system of claim 8, wherein the first wireless interface is configured to communicate the second signal at the second frequency band through the switch, while the second wireless interface is configured to communicate the fourth signal at the fourth frequency band, in response to the switch selecting the second signal.

14. The system of claim 8, wherein the first wireless interface is configured to communicate the first signal at the first frequency band, while the second wireless interface is configured to communicate the third signal at the third frequency band through the switch, in response to the switch selecting the third signal.

15. The system of claim 8, wherein the second wireless interface is configured to communicate the fourth signal at the fourth frequency band, while the first wireless interface is configured to communicate the first signal at the first frequency band and the second signal at the second frequency band, in response to the switch selecting the second signal.

16. The system of claim 1,
wherein the first wireless interface includes:
a first port to communicate a first signal at the first frequency band, and
a second port to communicate a second signal at the second frequency band, and
wherein the second wireless interface includes:
a third port to transmit a third signal at the third frequency band or a fourth signal at the fourth frequency band, and
a fourth port to receive a fifth signal at the third frequency band or a sixth signal at the fourth frequency band.

17. The system of claim 15, further comprising:
a mode switch to selectively couple the third port of the second wireless interface or the fourth port of the second wireless interface to the switch or the multi-band filter, according to a communication mode of the second wireless interface.

18. The system of claim 17,
wherein the switch includes:
a first switch port coupled to the second port of the first wireless interface,
a second switch port, and
a third switch port coupled to the multi-band filter, wherein the switch is configured to selectively couple the first switch port or the second switch port to the third switch port, and
wherein the mode switch includes:
a fourth switch port coupled to the third port of the second wireless interface,
a fifth switch port coupled to the fourth port of the second wireless interface,
a sixth switch port coupled to the second switch port of the switch, and
a seventh switch port coupled to the multi-band filter, wherein the mode switch is configured to selectively couple i) the fourth switch port to the sixth switch port or the seventh switch port or ii) the fifth switch port to the sixth switch port or the seventh switch port, according to the communication mode of the second wireless interface.

19. The system of claim 18, wherein the multi-band filter includes:
a first multi-band filter port coupled to the first port of the first wireless interface,
a second multi-band filter port coupled to the third switch port of the switch, and
a third multi-band filter port coupled to the fourth port of the second wireless interface, the system further comprising:
a first filter coupled between the first multi-band filter port of the multi-band filter and the first port of the first wireless interface;
a second filter coupled between the first switch port of the switch and the second port of the first wireless interface;
a third filter coupled between the second switch port of the switch and the sixth switch port of the mode switch; and
a fourth filter coupled between the third multi-band filter port of the multi-band filter and the seventh switch port of the mode switch.

20. A method of simultaneous communication at two or more of a first frequency band, a second frequency band, a third frequency band, and a fourth frequency band, the method comprising:
selecting, by a switch from the second frequency band and the third frequency band, the second frequency band for communication during a first time period;
communicating, by a first wireless interface, a first data at the second frequency band via a single antenna during the first time period;
communicating, by a second wireless interface, a second data at the fourth frequency band via the single antenna during the first time period;
selecting, by the switch from the second frequency band and the third frequency band, the third frequency band for communication during a second time period;
communicating, by the first wireless interface, a third data at the first frequency band via the single antenna during the second time period; and
communicating, by the second wireless interface, a fourth data at the third frequency band or the fourth frequency band via the single antenna during the second time period.
